(19) United States
(12) Patent Application Publication
(10) Pub. No.: US 2019/0095829 A1
(43) Pub. Date: Mar. 28, 2019

(54) Apparatus and Method for Sport Field Management

(71) Applicant: BOE TECHNOLOGY GROUP CO., LTD., Beijing (CN)

(72) Inventors: Hailan JIN, Beijing (CN); Hui DU, Beijing (CN); Qi YANG, Bejing (CN); Yang HAN, Beijing (CN)

(21) Appl. No.: 16/038,520

(22) Filed: Jul. 18, 2018

(30) Foreign Application Priority Data
Sep. 28, 2017 (CN) 201710900786.6

(51) Int. Cl. G06Q 10/06; G06K 9/00; A63B 24/00

(52) U.S. Cl. CPC G06Q 10/0635; G06K 9/00342; A63B 2220/89; A63B 2024/0071; A63B 2220/803; A63B 24/0062

(57) ABSTRACT

The present disclosure provides an apparatus and method for sport field management. The apparatus for sport field management comprises: a first data obtaining component, which is disposed at an entrance of respective sports channels and configured to obtain a sports risk index and a physical fatigue index of a user in a case where the user enters the sports channel; a load index calculating component, which is configured to calculate a channel load index of respective sports channels based on the sports risk index and the physical fatigue index of the user entering a corresponding sports channel within a first preset period; and a personnel assignment calculating component, which is configured to calculate the number of supervisors corresponding to respective sports channels based on the channel load index of the respective sports channels.

### CROSS-REFERENCE TO RELATED APPLICATION

This application claims the priority of Chinese Patent Application No. 201710900786.6 submitted to the Chinese Intellectual Property Office on Sep. 28, 2017, the disclosure of which is incorporated herein in its entirety by reference.

### TECHNICAL FIELD

The present disclosure relates to the technical field of venue management, and particularly relates to an apparatus and method fir sport field management.

### BACKGROUND OF THE. INVENTION

With the improvement of people's living standards, it has become a fashion to perform corresponding sports on sport fields (for example, ski resorts, running parks, bicycle riding parks, and so on). In current management of sport fields, monitoring is generally conducted by a supervisor through successive patrol of respective channels in the sport field. However, this kind of manual patrol management does not work well. For example, when an accident occurs and a user needs emergency rescue, the supervisor may be patrolling a location far away from the site of the incident, thus resulting in failure to provide timely rescue.

As can be seen, how to provide a solution for scientific and effective management of a sport field becomes an urgent technical problem to be solved in the art.

### SUMMARY

The present disclosure has been accomplished in order to at least partially solve the problems in the prior art. The present disclosure provides an apparatus and method for sport field management.

According to one aspect of the disclosure, there is provided an apparatus for sport field management applied in a sport field with a plurality of sports channels, the apparatus for sport field management comprising:

a first data obtaining component, which is disposed at an entrance of respective sports channels and configured to obtain a sports risk index and a physical fatigue index of a user in a case where the user enters the sports channel;

a load index calculating component, which is configured to calculate a channel load index of respective sports channels based on the sports risk index and the physical fatigue index of the user entering a corresponding sports channel within a first preset period; and

a personnel assignment calculating component, which is configured to calculate the number of supervisors corresponding to respective sports channels based on the channel load index of the respective sports channels.

In some embodiments, the first data obtaining component may obtain the sports risk index and the physical fatigue index of the user from a wearable device worn by the user, and the wearable device is configured to, in a case where the user leaves the sports channel, calculate the sports risk index and the physical fatigue index of the user based on the user's motion information in a previous sports channel and physiological information after leaving the previous sports channel.

In some embodiments, the load index calculating component may calculate a channel load index Fₙ of the n^{th} sports channel by the following equation:

$${F}_{n} = {α}_{1} * {\sum }_{i = 1}^{{S}_{n}} {D}_{n\_i} + {α}_{2} * {\sum }_{i = 1}^{{S}_{n}} {P}_{n\_i}$$

where 1≤n≤N and n is an integer, N is the total number of sports channels in the sport field, α₁ and α₂ are preset weight coefficients and both greater than or equal to 0, Sₙ is the total number of users entering the n^{th} sports channel within the first preset period, Dₙ_{_}ᵢ is the sports risk index of the i^{th} user entering the n^{th} sports channel within the first preset period, and is the physical fatigue index of the user entering the n^{th} sports channel within a preset period.

In some embodiments, the personnel assignment calculating component may calculate the number Qₙ of supervisors corresponding to the n^{th} sports channel by the following equation:

$${Q}_{n} = \frac{{F}_{n}}{{\sum }_{j = 1}^{N} {F}_{j}} * {S}^{′}$$

where 1≤n≤N and n is an integer, N is the total number of sports channels in the sport field, Fₙ is the channel load index of the n^{th} sports channel, and S′ is the total number of supervisors in the sport field.

In some embodiments, the motion information may include: a total passing time of passing through the sports channel, a total static time of not moving in the sports channel, and the total number of times of dangerous actions;

the physiological information may include: information on heart rate variability;

the wearable device may include:

a motion information obtaining part, which is configured to obtain the total passing time of passing through the sports channel, the total static time of not moving in the sports channel, and the total number of times of dangerous actions of the user;

a risk index calculating part, which is configured to calculate the sports risk index of the user based on the total passing time, the total static time and the total number of times of dangerous actions of the user;

a physiological information obtaining part, which is configured to obtain the information on heart rate variability after the user passes through the sports channel; and

a fatigue index calculating part, which is configured to calculate the physical fatigue index of the user based on the information on heart rate variability of the user.

In some embodiments, the motion information obtaining part may include:

a three-axis acceleration sensor, which is configured to detect accelerations of the user in three axial directions every predetermined period in a case where the user is in the sports channel;

a motion state recognition subpart, which is configured to recognize a body motion state of the user based on the accelerations of the user in the three axial directions, the body motion state including a static state, a normal motion state, and a dangerous action state;

a first timing subpart, which is configured to obtain the total passing time of the user passing through the sports channel;

a second timing subpart, which is configured to obtain the total time of the user staying static in the sports channel as the total static time based on the recognized result of the motion state recognition subpart; and

a dangerous action counting subpart, which is configured to count the total number of times of doing dangerous actions in the sports channel by the user as the total number of times of dangerous actions based on the recognized result of the motion state recognition subpart.

In some embodiments, the risk index calculating part may calculate the sports risk index D of the user by the following equation:

$$D = {β}_{1} * \frac{{t}_{2}}{{t}_{1}} + {β}_{2} * C$$

where β₁ and β₂ are preset weight coefficients and both greater than or equal to 0, t₁ is the total passing time, t₂ is the total static time, and C is the total number of times of dangerous actions.

In some embodiments, the physiological information obtaining part may include:

a heart rate detecting sensor, which is configured to detect heart rate data of the user within a second preset period after the user leaves the sports channel; and

a data process subpart, which is configured to process the heart rate data to obtain the information on heart rate variability of the user.

In some embodiments, the apparatus for sport field management may further include:

a plurality of second data obtaining components distributed in a non-sports channel area of the sport field, each of which corresponding to one data collecting area and configured to, in a case where a user moves into the data collecting area, obtain the sports risk index and the physical fatigue index of the user from a wearable device worn by the user;

a first comparison component, which is configured to compare the physical fatigue index obtained by the second data obtaining component with a preset physical fatigue index;

a first push component, which is configured to push a message recommending a rest to the user in a case where the first comparison component determines that the physical fatigue index is equal to or greater than the preset physical fatigue index;

a second comparison component, which is configured to compare the sports risk index obtained by the second data obtaining component with a preset sports risk index in a case where the first comparison component determines that the physical fatigue index is smaller than the preset physical fatigue index; and

a second push component, which is configured to push a message recommending a sports channel with a lower difficulty level to the user in a case where the second comparison component determines that the sports risk index is equal to or greater than the preset sports risk index.

In some embodiments, the apparatus for sport field management may further include:

a plurality of monitor components distributed in the non-sports channel area of the sport field, each of which corresponding to one monitor area and configured to, in a case where a user moves into the corresponding monitor area, obtain and send ID information of the wearable device worn by the user; and

a warning component, which is configured to receive the ID information sent by the monitor component and raise an alarm in a case where the ID information of the wearable device worn by a certain user is not received within a third preset period.

In some embodiments, the first data obtaining component may read ID information of the wearable device worn by the user.

In some embodiments, the sport field may be selected from a group consisting of a ski resort, a running park, and a bicycle riding park.

In some embodiments, the non-sports channel area may be selected from a group consisting of a ski lift, a coffee room, a rest room and an equipment replacement center.

In some embodiments, based on the ID information sent by the monitor component, the apparatus for sport field management may locate the user to learn about preference information of the user.

According to another aspect of the disclosure, there is provided a method for sport field management comprising:

obtaining a sports risk index and a physical fatigue index of a user in a case where the user enters the sports channel;

calculating a channel load index of respective sports channels based on the sports risk index and the physical fatigue index of the user entering a corresponding sports channel within a first preset period; and

calculating the number of supervisors corresponding to respective sports channels based on the channel load index of respective sports channels.

In some embodiments, the sports risk index and the physical fatigue index of the user are obtained from the wearable device worn by the user, and in a case where the user leaves a previous sports channel, the wearable device calculates a sports risk index and a physical fatigue index of the user based on the user's motion information in the previous sports channel and physiological information after leaving the previous sports channel.

In some embodiments, a channel load index Fₙ of the n^{th} sports channel is calculated by the following equation:

$${F}_{n} = {α}_{1} * {\sum }_{i = 1}^{{S}_{n}} {D}_{n\_i} + {α}_{2} * {\sum }_{i = 1}^{{S}_{n}} {P}_{n\_i}$$

where 1≤n≤N and n is an integer, N is the total number of sports channels in the sport field, α₁ and α₂ are preset weight coefficients and both greater than or equal to 0, Sₙ is the total number of users entering the n^{th} sports channel within the first preset period, Dₙ_{_}ᵢ is the sports risk index of the i^{th} user entering the n^{th} sports channel within the first preset period, and Pₙ_{_}ᵢ is the physical fatigue index of the i^{th} user entering the n^{th} sports channel within a preset period.

In some embodiments, the number Qₙ of supervisors corresponding to the n^{th} sports channel is calculated by the following equation:

$${Q}_{n} = \frac{{F}_{n}}{{\sum }_{j = 1}^{N} {F}_{j}} * {S}^{′}$$

where 1≤n≤N and n is an integer, N is the total number of sports channels in the sport field, Fₙ is the channel load index of the n^{th} sports channel, and S′ is the total number of supervisors in the sport field.

According to yet another aspect of the disclosure, there is provided a method for sport field management, comprising:

obtaining a sports risk index and a physical fatigue index of a user in a case where the user enters the sports channel;

calculating a channel load index of respective sports channels based on the sports risk index and the physical fatigue index of the user entering a corresponding sports charnel within a first preset period:

calculating the number of supervisors corresponding to respective sports channels based on the channel load index of respective sports channels;

obtaining the sports risk index and the physical fatigue index of the user in a case where the user moves into a data collecting area in a non-sports channel area of the sport field;

comparing the physical fatigue index with a preset physical fatigue index;

pushing a message recommending a rest to the user in a case where it is determined that the physical fatigue index is equal to or greater than the preset physical fatigue index;

comparing the sports risk index with a preset sports risk index in a case where it is determined that the physical fatigue index is smaller than the preset physical fatigue index; and

pushing a message recommending a sports channel with a lower difficulty level to the user in a case where it is determined that the sports risk index is equal to or greater than the preset sports risk index.

In some embodiments, the method for sport field management may further include:

obtaining and sending ID information of a wearable device worn by the user in a case where the user enters a non-sports channel monitor area in the sport field; and

raising an alarm in a case where the ID information of the wearable device worn by the user is not received within a third preset period.

### BRIEF DESCRIPTION OF THE FIGURES

FIG. 1 is a block diagram illustrating a configuration of the apparatus for sport field management according to the first exemplary embodiment of the disclosure;

FIG. 2 is a block diagram illustrating a configuration of the wearable device in FIG. 1;

FIG. 3 is a flowchart illustrating a method for sport field management according to the second exemplary embodiment of the disclosure; and

FIG. 4 is a flowchart illustrating a method for sport field management according to the third exemplary embodiment of the disclosure.

### DETAILED DESCRIPTION

To improve understanding of the technical solution of the present disclosure for those skilled in the art, the apparatus and method for sport field management provided in the disclosure will be described below in detail in conjunction with the accompanying drawings.

In the exemplary embodiments of the disclosure, the sport field may be a venue for users to do sports, such as ski resorts, running parks, bicycle riding parks, and so on, and usually comprises a plurality of sports channels. The following exemplary embodiments are explained taking the sport field being a ski resort as an example.

### First Exemplary Embodiment

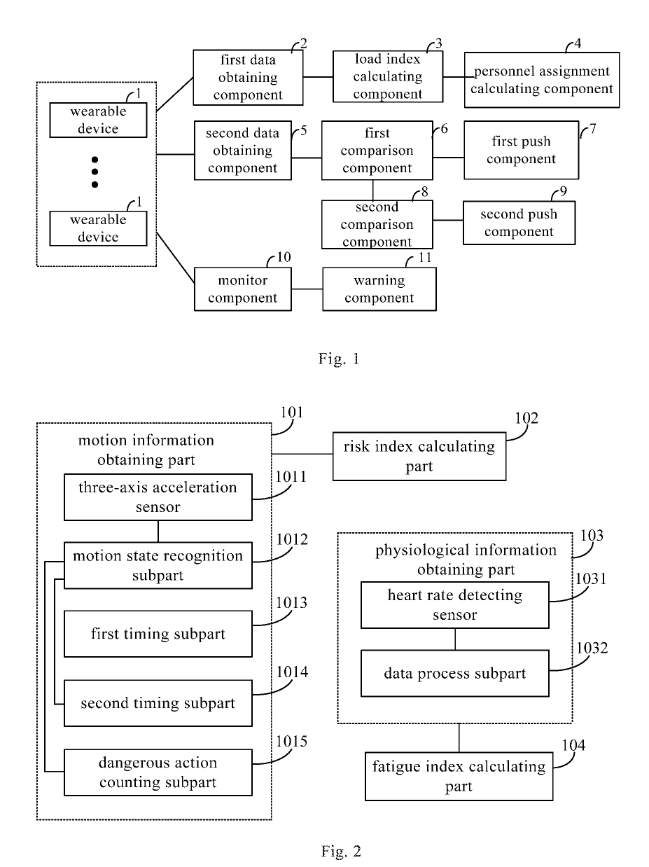

FIG. 1 is a block diagram illustrating a configuration of the apparatus for sport field management according to the first exemplary embodiment of the disclosure, and FIG. 2 is a block diagram illustrating a configuration of the wearable device in FIG. 1. As shown in FIGS. 1 and 2, the apparatus for sport field management includes: first data obtaining components 2, a load index calculating component 3, a personnel assignment calculating component 4 and a plurality of wearable devices 1.

Each user entering the sport field to do sports is assigned a wearable device 1, which may be, for example, a head-, wrist- or body mounted device wearable by the user. Each of the wearable devices 1 is pre-stored with ID information of the device.

In the exemplary embodiment of the disclosure, the wearable device 1 is configured to calculate a sports risk index and a physical fatigue index of the user based on the user's motion information in the sports channel and physiological information after leaving the sports channel.

The first data obtaining components 2 correspond to the sports channels one by one. The first data obtaining components 2 are disposed at an entrance of respective sports channels and configured to, when the user enters the sports channels, obtain the sports risk index and the physical fatigue index of the user from the wearable device 1 worn by the user. In addition, the first data obtaining component 2 may read ID information of the wearable device worn by the user.

In the exemplary embodiments of the disclosure, the first data obtaining components 2 may be implemented as DSP or embedded chips. However, the first data obtaining component 2 of the disclosure is not limited thereto, but may be any other device or obtaining circuit capable of obtaining data from the wearable device 1.

The load index calculating component 3 is configured to calculate a channel load index of respective sports channels based on the sports risk index and the physical fatigue index of the user entering a corresponding sports channel within a first preset period.

The personnel assignment calculating component 4 is configured to calculate the number of supervisors corresponding to respective sports channels based on the channel load index of the respective sports channels.

In the exemplary embodiments of the disclosure, the load index calculating component 3 and the personnel assignment calculating component 4 may be implemented as DSP or embedded chips. However, the load index calculating component 3 and the personnel assignment calculating component 4 of the disclosure are not limited thereto, but may be any other device or calculating circuit capable of calculation.

It should be understood that, in the exemplary embodiment, the wearable device 1 calculates the sports risk index and the physical fatigue index of the user, but the disclosure is not limited thereto. The first data obtaining component 2 or the load index calculating component 3 may calculate the sports risk index and the physical fatigue index of the user based on the user's motion information in the sports channel and physiological information after leaving the sports channel.

The apparatus for sport field management provided in the disclosure can realize effective assignment of supervisors. To improve understanding of the present disclosure for those skilled in the art, the specific process of realizing assignment of supervisors by the apparatus for sport field management of the disclosure will now be described in detail with reference examples. In that, the first preset period is assumed to be one hour.

Supervisors are not assigned during the first hour (the first preset period) after operation of the sport field. Respective users in the sport field do sports in a corresponding sports channel according to their own needs. A built-in sensor in the wearable device 1 may detect motion information of the user in the sports channel and detect the physiological information of user after the user leaves the sports channel. Then, the wearable device 1 calculates and stores the sports risk index and the physical fatigue index of the user based on the obtained motion information and physiological information.

As a specific application scene, the sport field is a ski resort. In this case, a motion monitor instruction sending component may be provided at an entrance of each ski channel, and a fatigue monitor instruction sending component may be provided on a ski lift (which needs to be used before the next ski). When a user enters the entrance of the ski channel, the motion monitor instruction sending component sends a motion monitor instruction to the wearable device 1 of the user, and the built-in sensor of the wearable device 1 starts monitoring the motion information of the user in the sports channel according to the received motion monitor instruction. When the user exits the ski channel and takes the ski lift to the peak or the next ski channel, the fatigue monitor instruction sending component in the ski lift sends a fatigue monitor instruction to the wearable device 1 of the user, and the built-in sensor of the wearable device 1 starts monitoring the physiological information of the user according to the received fatigue monitor instruction (at this time, the user is in a state of sitting still and the physiological information is relatively more precise).

When the user enters the next sports channel to continue the sports, the first data obtaining component 2 at the entrance of the sports channel obtains the sports risk index and the physical fatigue index of the user from the wearable device 1 worn by the user.

At the end of the first hour after operation of the sport field, each of the first data obtaining components 2 may obtain the sports risk index and the physical fatigue index of users entering the corresponding sports channel during the past one hour.

Then, the load index calculating component 3 calculates a channel load index corresponding to respective sports channels based on the sports risk index and the physical fatigue index of the user entering the corresponding sports channel obtained by respective first data obtaining components 2.

In the exemplary embodiment of the disclosure, the load index calculating component 3 calculates the channel load index Fₙ of the nth sports channel by the following equation:

$${F}_{n} = {α}_{1} * {\sum }_{i = 1}^{{S}_{n}} {D}_{n\_i} + {α}_{2} * {\sum }_{i = 1}^{{S}_{n}} {P}_{n\_i}$$

where 1≤n≤N and n is an integer, N is the total number of sports channels in the sport field, α₁ and α₂ are preset weight coefficients and both greater than or equal to 0, Sₙ is the total number of users entering the n^{th} sports channel within the first preset period, Dₙ_{_}ᵢ is the sports risk index of the i^{th} user entering the n^{th} sports channel within the first preset period, and Pₙ_{_}ᵢ is the physical fatigue index of the i^{th} user entering the n^{th} sports channel within a preset period.

It should be noted that the values of α₁ and α₂ may be set and adjusted according to actual requirements.

In addition, in the exemplary embodiment of the disclosure, the channel load index of respective sports channels may be calculated with other algorithms based on the sports risk index and the physical fatigue index; the specific algorithms are not listed here one by one. Those skilled in the art should know that any technical means based on the sports risk index and the physical fatigue index of the user entering the corresponding sports channel obtained by the first data obtaining component 2, and calculating the channel load index of the sports channel with certain algorithm falls into the scope of the disclosure.

After the load index calculating component 3 calculates the channel load index of respective sports channels, the personnel assignment calculating component 4 calculates the number of supervisors corresponding to respective sports channels based on the channel load index of the respective sports channels.

In the exemplary embodiment of the disclosure, the personnel assignment

$${Q}_{n} = \frac{{F}_{n}}{{\sum }_{j = 1}^{N} {F}_{j}} * {S}^{′}$$

calculating component 4 calculates the number Qₙ of supervisors corresponding to the n^{th} sports channel by the following equation:

where 1≤n≤N and n is an integer, N is the total number of sports channels in the sport field, Fₙ is the channel load index of the n^{th} sports channel, and S′ is the total number of supervisors in the sport field.

It should be noted that if the number Qₙ of supervisors corresponding to the n^{th} sports channel calculated by the above equation is not an integer, and the numbers Qₙ can be rounded off to an integer during actual personnel assignment.

It should be noted that in the exemplary embodiment of the disclosure, the number of supervisors corresponding to respective sports channels may be calculated with other algorithms based on the channel load index of respective sports channels; the specific algorithms are not listed here one by one. Those skilled in the art should know that any technical means based on the channel load index of respective sports channels calculated by the load index calculating component 3, and calculating the number of supervisors corresponding to respective sports channels with certain algorithm falls into the scope of the disclosure.

In an initial state during the second hour after operation of the sport field, the supervisors may be assigned according to the result calculated by the personnel assignment calculating component 4 so that a proper number of supervisors are assigned to each of the sports channels.

It should be noted that each time the user leaves a sports channel, the wearable device 1 will calculate and store the current sports risk index and physical fatigue index of the user, and when the user enters the next sports channel, the first data obtaining component 2 at the entrance of the next sports channel obtains only the newest data (the latest stored data) of the sports risk index and the physical fatigue index stored in the wearable device 1.

During the second hour after operation of the sport field, the wearable device 1 continues calculation of the sports risk index and the physical fatigue index of the user according to the sports situation of the user, and the first data obtaining component 2 continues to obtain the sports risk index and the physical fatigue index of the user entering the corresponding sports channel during the second hour after operation of the sport field. The load index calculating component 3 calculates the channel load index of respective sports channels during the second hour after operation of the sport field based on the data obtained by respective first data obtaining components 2. The personnel assignment calculating component 4 calculates the number of supervisors desired to be assigned to respective sports channels during the third hour after operation of the sport field based on the channel load index of respective sports channels calculated by the load index calculating component 3 during the second hour after operation of the sport field.

Such a process is repeated, i.e., calculating the number of supervisors desired to be assigned to respective sports channels during the next hour based on the channel load index of respective sports channels during the previous hour.

It should be noted that the above first preset period being 1 hour is only illustrative and does not configure any limitation to the technical solution of the disclosure. In practical applications, the first preset period may be set and adjusted according to actual requirements.

As can be seen from the above, the apparatus for sport field management provided in the disclosure can reasonably assign the number of superiors desired for each of the sports channels, thus scientifically and effectively improving the management efficiency of the sport field.

In the exemplary embodiment of the disclosure, the motion information includes: a total passing time of passing through the sports channel, a total static time of not moving in the sports channel, and the total number of times of dangerous actions; the physiological information includes: information on heart rate variability; the wearable device 1 includes: a motion information obtaining part 101, a risk index calculating part 102, a physiological information obtaining part 103 and a fatigue index calculating part 104.

In the exemplary embodiment of the disclosure, the motion information obtaining part 101, the risk index calculating part 102, the physiological information obtaining part 103 and the fatigue index calculating part 104 may all be implemented as DSP or embedded chips. However, the disclosure is not limited thereto. For example, the motion information obtaining part 101 and the physiological information obtaining part 103 may be any other device or obtaining circuit capable of obtaining information, and the risk index calculating part 102 and the fatigue index calculating part 104 may be any other device or calculating circuit capable of calculation.

In the exemplary embodiment of the disclosure, the motion information obtaining part 101 is configured to obtain the total passing time of passing through the sports channel, the total static time of not moving in the sports channel, and the total number of times of dangerous actions of the user.

In the exemplary embodiment of the disclosure, the motion information obtaining part 101 includes: a three-axis acceleration sensor 1011, a motion state recognition subpart 1012, a first timing subpart 1013, a second timing subpart 1014 and a dangerous action counting subpart 1015.

In the exemplary embodiment of the disclosure, the motion state recognition subpart 1012, the first timing subpart 1013, the second timing subpart 1014 and the dangerous action counting subpart 1015 may all be implemented as DSP or embedded chips. However, the disclosure is not limited thereto. For example, the motion state recognition subpart 1012 may be any other device or recognition circuit capable of recognizing a motion state, the first timing subpart 1013 and the second timing subpart 1014 may be any other device, timer or timing circuit capable of timing, and the dangerous action counting subpart 1015 may be any other device, counter or counting circuit capable of counting.

The three-axis acceleration sensor 1011 is configured to detect accelerations of the user in three axial directions every predetermined period when the user is in the sports channel. The three-axis acceleration sensor 1011 is a known senor, and the specific structure and working principles thereof are not explained herein.

The motion state recognition subpart 1012 is configured to recognize a body motion state of the user based on the accelerations of the user in the three axial directions, the body motion state including a static state, a normal motion state, and a dangerous action state; when the accelerations of the user in the three axial directions are all zero, it indicates that the user does not move (may be fallen down or in a rest), and thus it is recognized that the user is in a static state; when at least one of the accelerations of the user in the three axial directions is not zero and the accelerations in the three axial directions are all smaller than or equal to a preset acceleration threshold on the corresponding axial direction, it indicates that the user is in a normal motion, and thus it is recognized that the user is in a normal motion state; when the accelerations of the user in the three axial directions are all equal to or greater than the preset acceleration threshold on the corresponding axial direction, it indicates that the user has a too large acceleration in at least one of the axial directions (may be in a rapid downhill), and thus it is recognized that the user is in a dangerous action state.

The first timing subpart 1013 is configured to obtain the total passing of the user passing through the sports channel.

The second timing subpart 1014 is configured to obtain the total time of the user staying static in the sports channel as the total static time based on the recognized result of the motion state recognition subpart.

The dangerous action counting subpart 1015 is configured to count the total number of times of doing dangerous actions in the sports channel by the user as the total number of times of dangerous actions based on the recognized result of the motion state recognition subpart.

It should be noted that during the process of counting the total number of times of doing dangerous actions in the sports channel by the user based on the recognized result of the motion state recognition subpart, one time of dangerous action begins when the user changes from a non-dangerous action state into a dangerous action state, and ends when the user changes from the dangerous action state back to a non-dangerous action state.

The risk index calculating part 102 is configured to calculate the sports risk index of the user based on the total passing time, the total static time and the total number of times of dangerous actions of the user.

In the exemplary embodiment of the disclosure, the risk index calculating part 102 calculates the sports risk index D of the user by the following equation:

$$D = {β}_{1} * \frac{{t}_{2}}{{t}_{1}} + {β}_{2} * C$$

where β₁ and β₂ are preset weight coefficients and both greater than or equal to 0, t₁ is the total passing time, t₂ is the total static time, and C is the total number of times of dangerous actions.

It should be noted that the values of β₁ and β₂ may be set and adjusted according to actual requirements.

In addition, in the exemplary embodiment of the disclosure, the sports risk index of the user may be calculated with other algorithms based on the total passing time, the total static time and the total number of times of dangerous actions; the specific algorithms are not listed here one by one. Those skilled in the art should know that any technical means based on the total passing time, the total static time and the total number of times of dangerous actions, and calculating the sports risk index of the user with certain algorithm falls into the scope of the disclosure.

The physiological information obtaining part 103 is configured to obtain the information on heart rate variability after the user passes through the sports channel.

In the exemplary embodiment of the disclosure, the physiological information obtaining part 103 includes a heart rate detecting sensor 1031 and a data process subpart 1032.

In the exemplary embodiment of the disclosure, the heart rate detecting sensor 1031 is configured to detect heart rate data of the user within a second preset period (e.g., 5 minutes) after the user leaves the sports channel. The heart rate detecting sensor 1031 may be, for example, a pulse sensor, an infrared ear heart rate sensor, an optical heart rate sensor, and so on.

The data process subpart 1032 is configured to process the heart rate data to obtain the information on heart rate variability of the user.

In the exemplary embodiments of the disclosure, the data process subpart 1032 may be implemented as DSP or embedded chips. However, the disclosure is not limited thereto. The data process subpart 1032 may be any other device or process circuit capable of data process.

In the exemplary embodiment of the disclosure, the information on heart rate variability (HRV) specifically includes: Standard Deviation of NN Intervals (SDNN), Square Root of the Mean Squared Differences of Successive NN Intervals (RMSSD), Percentage of the number of Interval Differences of Successive NN Intervals greater than 50 ms in total number of NN Intervals (PNN50), Low Frequency (LF, typically in a range of 0.04 Hz˜0.15 Hz) power, a ratio of LF power to High Frequency (HF, typically in a range of 0.15 Hz˜0.40 Hz) power (LF/HF) and a nonlinear index parameter (based on Poincare plot).

The more fatigue the user is, the smaller values of the time domain indicators (SDNN, RMSSD, and PNN50) are, the larger values of the frequency domain indicators (LF, LF/HF) are, and the smaller values of the nonlinear index parameters are. The degree of fatigue is negatively correlated with the time domain indicators and the nonlinear index parameters, and is positively correlated with the frequency domain indicators.

The process of obtaining information on heart rate variability based on the heart rate data described above is a known technique and will not be described in detail in this disclosure.

The fatigue index calculating part 104 is configured to calculate the physical fatigue index of the user based on the information on heart rate variability of the user.

In the exemplary embodiment of the disclosure, the risk index calculating part 104 calculates the physical fatigue index P of the user by the following equation:

P=−γ₁*A₁−γ₂*A₂−γ₃*A₃+γ₄*A₄+γ₅*A₅−γ₆*A₆

where γ₁, γ₂, γ₃, γ₄, γ₅ and γ₆ are preset weight coefficients and all greater than or equal to 0, A₁ is SDNN, A₂ is RMSSD, A₃ is PNN50, A₄ is LF power, A₅ is LF/HF, and A₆ is a nonlinear index parameter. The larger the value of P is, the more fatigue the user is.

It should be noted that the values of γ₁, γ₂, γ₃, γ₄, γ₅ and γ₆ may be set and adjusted according to actual requirements.

In addition, in the exemplary embodiment of the disclosure, the physical fatigue index of the user may be calculated with other algorithms based on the SDNN, RMSSD, PNN50, LF, LF/HF and nonlinear index parameters; the specific algorithms are not listed here one by one. Those skilled in the art should know that any technical means based on the SDNN, RMSSD, PNN50, LF, LF/HF and nonlinear index parameters, and calculating the physical fatigue index of the user with certain algorithm falls into the scope of the disclosure. Apparently, the physical fatigue index of the user may also be calculated with part of the indices in the information on heart rate variability, which also falls into the scope of the disclosure.

The apparatus for sport field management provided in the disclosure can not only reasonably assign the number of superiors for each of the sports channels, but also push messages to and monitor users in the sport field.

In the exemplary embodiment of the disclosure, the apparatus for sport field management further includes: a first comparison component 6, a first push component 7, a second comparison component 8, a second push component 9, and a plurality of second data obtaining components 5. The plurality of second data obtaining components 5 are distributed in a non-sports channel area (e.g., ski lift, coffee room, rest room or equipment replacement center) of the sport field, each of which corresponding to one data collecting area, and configured to, when a user moves into the data collecting area, obtain the sports risk index and the physical fatigue index of the user from the wearable device 1 worn by the user.

The first comparison component 6 is configured to compare the physical fatigue index obtained by the second data obtaining component 5 with a preset physical fatigue index.

The first push component 7 is configured to push a message recommending a rest to the user when the first comparison component 6 determines that the physical fatigue index is equal to or greater than the preset physical fatigue index.

The second comparison component 8 is configured to compare the sports risk index obtained by the second data obtaining component 5 with a preset sports risk index when the first comparison component 6 determines that the physical fatigue index is smaller than the preset physical fatigue index.

When the second comparison component 8 determines that the sports risk index is equal to or greater than the preset sports risk index, which indicates that the user is not fatigue now but the previous sports channel is relatively dangerous for the user (the user is not capable enough of coping with the sports in the previous sports channel), the second push component 9 is configured to push a message recommending a sports channel with a lower difficulty level to the user.

It should be noted that when the second comparison component 8 determines that the sports risk index is smaller than the preset sports risk index, which indicates that the user is not fatigue now and the previous sports channel is not dangerous for the user, no message is pushed to the user.

In the exemplary embodiment of the disclosure, the first comparison component 6, the first push component 7, the second comparison component 8, the second push component 9, and the plurality of second data obtaining components 5 may all be implemented as DSP or embedded chips. However, the disclosure is not limited thereto. For example, similar to the first data obtaining component 2, the second data obtaining component 5 may also be any other device or obtaining circuit capable of obtaining data from the wearable device 1; the first comparison component 6 and the second comparison component 8 may be any other device or comparison circuit capable of comparing data; the first push component 7 and the second push component 9 may be any other device or communication circuit capable of sending a message.

In the exemplary embodiment of the disclosure, the apparatus for sport field management further includes a warning component 11 and a plurality of monitor components 10.

The plurality of monitor components 10 are distributed in the non-sports channel area (e.g., ski lift, coffee room, rest room or equipment replacement center) of the sport field, each of which corresponding to one monitor area and configured to, when a user moves into the corresponding monitor area, obtain ID information of the wearable device 1 worn by the user and send it to the warning component 11.

It should be noted that based on the ID information sent by the monitor component 10, the user may be effectively located, and preference information of the user, such as rest or dinner preferences, may be better learned, thus helping to offer better service to the user.

The warning component 11 is configured to receive the ID information sent by the monitor component 10 and raise an alarm when the ID information of the wearable device 1 worn by a certain user is not received within a third preset period (e.g., one hour).

Generally, a user will take a rest at a non-sports channel area after doing sports for a period of time. When the monitor component 10 at the non-sports channel area has not found a certain user for a long time, it can be inferred that the user is in an abnormal state (e.g., injured), and then a supervisor may be dispatched to search for the user.

In the exemplary embodiments of the disclosure, the warning component 11 and the monitor component 10 may both be implemented as DSP or embedded chips. However, the disclosure is not limited thereto. For example, the warning component 11 may be any other device or warning circuit capable of raising an alarm; and the monitor component 10 may be any device or monitor circuit capable of obtaining and sending a message.

The first exemplary embodiment of the disclosure provides an apparatus for sport field management which can realize reasonable assignment of the number of supervisors for each of the sports channels and conduct monitoring and warning regarding users in the sport field.

### Second Exemplary Embodiment

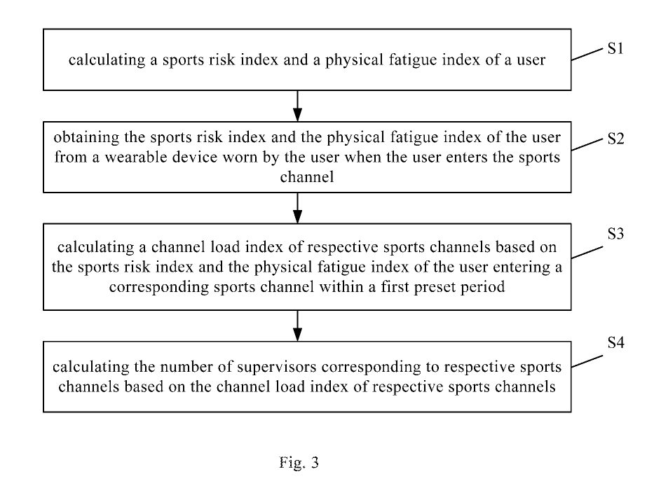

FIG. 3 is a flowchart illustrating a method for sport field management according to the second exemplary embodiment of the disclosure, which is based on the apparatus for sport field management according to the first exemplary embodiment of the disclosure. As shown in FIG. 3, the method for sport field management includes:

Step S1, calculating a sports risk index and a physical fatigue index of a user by a wearable device based on the user's motion information in the sports channel and physiological information after leaving the sports channel when the user leaves the sports channel.

Step S2, obtaining the sports risk index and the physical fatigue index of the user by a first data obtaining component from the wearable device worn by the user when the user enters the sports channel.

Step S3, calculating a channel load index of respective sports channels by a load index calculating component based on the sports risk index and the physical fatigue index of the user entering a corresponding sports channel within a first preset period.

Step S4, calculating the number of supervisors corresponding to respective sports channels by a personnel assignment calculating component based on the channel load index of respective sports channels.

For detailed description of these steps, please refer to corresponding contents in the first exemplary embodiment of the disclosure, which will not be repeated here.

The second exemplary embodiment of the disclosure provides a method for sport field management which can realize reasonable assignment of the number of supervisors for each of the sports channels.

### Third Exemplary Embodiment

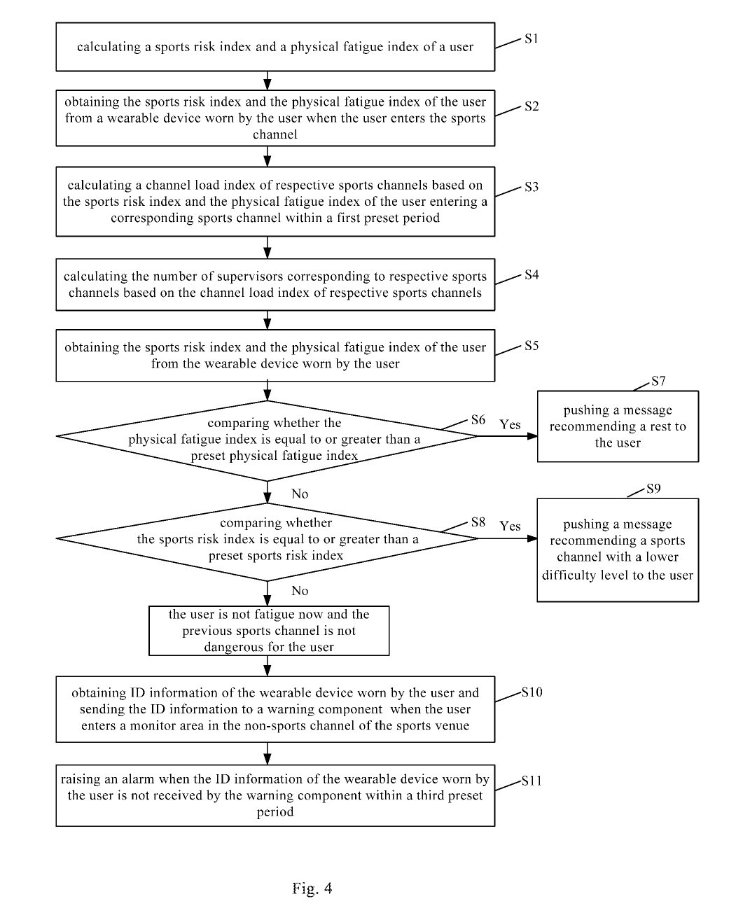

FIG. 4 is a flowchart illustrating a method for sport field management according to the third exemplary embodiment of the disclosure, which is based on the apparatus for sport field management according to the first exemplary embodiment of the disclosure. As shown in FIG. 4, in addition to steps S1 to S4 as in the second exemplary embodiment of the disclosure, the method for sport field management further includes steps S5 to S11. Only steps S5 to S11 will be described in the following contents.

Step S5, obtaining the sports risk index and the physical fatigue index of the user by a second data obtaining component from the wearable device worn by the user when the user moves into a data collecting area in a non-sports channel area of the sport field.

Step S6, comparing the physical fatigue index obtained by the second data obtaining component with a preset physical fatigue index by a first comparison component.

When the first comparison component determines that the physical fatigue index is equal to or greater than the preset physical fatigue index, move to step S7; otherwise, move to step S8.

Step S7, pushing a message recommending a rest to the user by a first push component.

Step S8, comparing the sports risk index obtained by the second data obtaining component with a preset sports risk index by a second comparison component.

When the second comparison component determines that the sports risk index is equal to or greater than the preset sports risk index, move to step S9; otherwise, it indicates that the user is not fatigue now and the previous sports channel is not dangerous for the user, thus no message is pushed to the user.

Step S9, pushing a message recommending a sports channel with a lower difficulty level to the user by a second push component.

Step S10, obtaining ID information of the wearable device worn by the user and sending the ID information to a warning component by a monitor component when the user enters a monitor area in the non-sports channel of the sport field.

Step S11, raising an alarm by the warning component when the ID information of the wearable device worn by the user is not received by the warning component within a third preset period.

For detailed description of steps S5 to S11, please refer to corresponding contents in the first exemplary embodiment of the disclosure, which will not be repeated here.

It should be noted that in the drawings, the case where steps S5 to S9 and S10 to S11 are performed after steps S1 to S4 is merely illustrative and does not make any limitation to the technical solution of the disclosure. In the disclosure, steps S5 to S9 and S10 to S11 may be performed simultaneously with steps S1 to S4. In addition, steps S10 to S11 may be performed before or simultaneously with steps S5 to S9. These cases all fall into the scope of the disclosure.

The third exemplary embodiment of the disclosure provides a method for sport field management which can realize reasonable assignment of the number of supervisors for each of the sports channels and conduct monitoring and warning regarding users in the sport field.

It should be understood that the above embodiments are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

What is claimed is:

1. An apparatus for sport field management applied in a sport field with a plurality of sports channels, comprising:
a first data obtaining component, which is disposed at an entrance of respective sports channels and configured to obtain a sports risk index and a physical fatigue index of a user in a case where the user enters the sports channel;
a load index calculating component, which is configured to calculate a channel load index of respective sports channels based on the sports risk index and the physical fatigue index of the user entering a corresponding sports channel within a first preset period; and
a personnel assignment calculating component, which is configured to calculate the number of supervisors corresponding to respective sports channels based on the channel load index of the respective sports channels.

2. The apparatus for sport field management according to claim 1, wherein
the first data obtaining component obtains the sports risk index and the physical fatigue index of the user from a wearable device worn by the user, and the wearable device is configured to, in a case where the user leaves a previous sports channel, calculate the sports risk index and the physical fatigue index of the user based on the user's motion information in the previous sports channel and physiological information after leaving the previous sports channel.

3. The apparatus for sport field management according to claim 1, wherein
the load index calculating component calculates a channel load index Fₙ of the n^{th} sports channel by the following equation:
$${F}_{n} = {α}_{1} * {\sum }_{i = 1}^{{S}_{n}} {D}_{n\_i} + {α}_{2} * {\sum }_{i = 1}^{{S}_{n}} {P}_{n\_i}$$
where 1≤n≤N and n is an integer, N is the total number of sports channels in the sport field, α₁ and α₂ are preset weight coefficients and both greater than or equal to 0, Sₙ is the total number of users entering the n^{th} sports channel within the first preset period, Dₙ_{_}ᵢ is the sports risk index of the i^{th} user entering the n^{th} sports channel within the first preset period, and Pₙ_{_}ᵢ is the physical fatigue index of the user entering the n^{th} sports channel within a preset period.

4. The apparatus for sport field management according to claim 1, wherein
the personnel assignment calculating component calculates the number Qₙ of supervisors corresponding to the n^{th} sports channel by the following equation:
$${Q}_{n} = \frac{{F}_{n}}{{\sum }_{j = 1}^{N} {F}_{j}} * {S}^{′}$$
where 1≤n≤N and n is an integer, N is the total number of sports channels in the sport field, Fₙ is the channel load index of the n^{th} sports channel, and S′ is the total number of supervisors in the sport field.

5. The apparatus for sport field management according to claim 2, wherein
the motion information includes: a total passing time of passing through the sports channel, a total static time of not moving in the sports channel, and the total number of times of dangerous actions;
the physiological information includes: information on heart rate variability; and
the wearable device comprises:
a motion information obtaining part, which is configured to obtain the total passing time of passing through the sports channel, the total static time of not moving in the sports channel, and the total number of times of dangerous actions of the user;
a risk index calculating part, which is configured to calculate the sports risk index of a user based on the total passing time, the total static time and the total number of times of dangerous actions of the user;
a physiological information obtaining part, which is configured to obtain the information on heart rate variability after the user passes through the sports channel; and
a fatigue index calculating part, which is configured to calculate the physical fatigue index of the user based on the information on heart rate variability of the user.

6. The apparatus for sport field management according to claim 5, wherein
the motion information obtaining part comprises:
a three-axis acceleration sensor, which is configured to detect accelerations of the user in three axial directions every predetermined period in a case where the user is in the sports channel;
a motion state recognition subpart, which is configured to recognize a body motion state of the user based on the accelerations of the user in the three axial directions, the body motion state including a static state, a normal motion state, and a dangerous action state;
a first timing subpart, which is configured to obtain the total passing time of the user passing through the sports channel;
a second tuning subpart, which is configured to obtain the total time of the user staying static in the sports channel as the total static time based on the recognized result of the motion state recognition subpart; and
a dangerous action counting subpart, which is configured to count the total number of times of doing dangerous actions in the sports channel by the user as the total number of times of dangerous actions based on the recognized result of the motion state recognition subpart.

7. The apparatus for sport field management according to claim 5, wherein
the risk index calculating part calculates the sports risk index D of the user by the following equation:
$$D = {β}_{1} * \frac{{t}_{2}}{{t}_{1}} + {β}_{2} * C$$
where β₁ and β₂ are preset weight coefficients and both greater than or equal to 0, t₁ is the total passing time, t₂ is the total static time, and C is the total number of times of dangerous actions.

8. The apparatus for sport field management according to claim 5, wherein
the physiological information obtaining part comprises:
a heart rate detecting sensor, which is configured to detect heart rate data of the user within a second preset period after the user leaves the sports channel; and
a data process subpart, which is configured to process the heart rate data to obtain the information on heart rate variability of the user.

9. The apparatus for sport field management according to claim 1, further comprising:
a plurality of second data obtaining components distributed in a non-sports channel area of the sport field, each of which corresponding to one data collecting area and configured to, in a case where a user moves into the data collecting area, obtain the sports risk index and the physical fatigue index of the user from a wearable device worn by the user;
a first comparison component, which is configured to compare the physical fatigue index obtained by the second data obtaining component with a preset physical fatigue index;
a first push component, which is configured to push a message recommending a rest to the user in a case where the first comparison component determines that the physical fatigue index is equal to or greater than the preset physical fatigue index;
a second comparison component, which is configured to compare the sports risk index obtained by the second data obtaining component with a preset sports risk index in a case where the first comparison component determines that the physical fatigue index is smaller than the preset physical fatigue index; and
a second push component, which is configured to push a message recommending a sports channel with a lower difficulty level to the user in a case where the second comparison component determines that the sports risk index is equal to or greater than the preset sports risk index.

10. The apparatus for sport field management according to claim 9, further comprising:
a plurality of monitor components distributed in non-sports channel area of the sport field, each of which corresponding to one monitor area and configured to, in a case where a user moves into the corresponding monitor area, obtain and send ID information of the wearable device worn by the user; and
a warning component, which is configured to receive the ID information sent by the monitor component and raise an alarm in a case where the ID information of the wearable device worn by a certain user is not received within a third preset period.

11. The apparatus for sport field management according to claim 2, wherein
the first data obtaining component reads ID information of the wearable device worn by the user.

12. The apparatus for sport field management according to claim 1, wherein
the sport field is selected from a group consisting of a ski resort, a running park, and a bicycle riding park.

13. The apparatus for sport field management according to claim 9, wherein
the non-sports channel area is selected from a group consisting of a ski lift, a coffee room, a rest room and an equipment replacement center.

14. The apparatus for sport field management according to claim 10, wherein
based on the ID information sent by the monitor component, the apparatus for sport field management locates the user to learn about preference information of the user.

15. A method for sport field management, comprising:
obtaining a sports risk index and a physical fatigue index of a user in a case where the user enters the sports channel;
calculating a channel load index of respective sports channels based on the sports risk index and the physical fatigue index of the user entering a corresponding sports channel within a first preset period; and
calculating the number of supervisors corresponding to respective sports channels based on the channel load index of respective sports channels.

16. The method for sport field management according to claim 15, wherein
the sports risk index and the physical fatigue index of the user are obtained from a wearable device worn by the user, and in a case where the user leaves a previous sports channel, the wearable device calculates the sports risk index and the physical fatigue index of the user based on the user's motion information in the previous sports channel and physiological information after leaving the previous sports channel.

17. The method for sport field management according to claim 15, wherein
a channel load index Fₙ of the n^{th} sports channel is calculated by the following equation:
$${F}_{n} = {α}_{1} * {\sum }_{i = 1}^{{S}_{n}} {D}_{n\_i} + {α}_{2} * {\sum }_{i = 1}^{{S}_{n}} {P}_{n\_i}$$
where 1≤n≤N and n is an integer, N is the total number of sports channels in the sport field, α₁ and α₂ are preset weight coefficients and both greater than or equal to 0, Sₙ is the total number of users entering the n^{th} sports channel within the first preset period, Dₙ_{_}ᵢ is the sports risk index of the i^{th} user entering the n^{th} sports channel within the first preset period, and Pₙ_{_}ᵢ is the physical fatigue index of the i^{th} user entering the n^{th} sports channel within a preset period.

18. The method for sport field management according to claim 15, wherein
the number Qₙ of supervisors corresponding to the n^{th} sports channel is calculated by the following equation:
$${Q}_{n} = \frac{{F}_{n}}{{\sum }_{j = 1}^{N} {F}_{j}} * {S}^{′}$$
where 1≤n≤N and n is an integer, N is the total number of sports channels in the sport field, Fₙ is the channel load index of the n^{th} sports channel, and S′ is the total number of supervisors in the sport field.

19. A method for sport field management, comprising:
obtaining a sports risk index and a physical fatigue index of a user in a case where the user enters the sports channel;
calculating a channel load index of respective sports channels based on the sports risk index and the physical fatigue index of the user entering a corresponding sports channel within a first preset period;
calculating the number of supervisors corresponding to respective sports channels based on the channel load index of respective sports channels;
obtaining the sports risk index and the physical fatigue index of the user in a case where the user moves into a data collecting area in a non-sports channel area of the sport field;
comparing the physical fatigue index with a preset physical fatigue index;
pushing a message recommending a rest to the user in a case where it is determined that the physical fatigue index is equal to or greater than the preset physical fatigue index;
comparing the sports risk index with a preset sports risk index in a case where it is determined that the physical fatigue index is smaller than the preset physical fatigue index; and
pushing a message recommending a sports channel with a lower difficulty level to the user in a case where it is determined that the sports risk index is equal to or greater than the preset sports risk index.

20. The method for sport field management according to claim 19, further comprising:
obtaining and sending ID information of a wearable device worn by the user in a case where the user enters a non-sports channel monitor area in the sport field; and
raising an alarm in a case where the ID information of the wearable device worn by the user is not received within a third preset period.
